(19) United States
(12) Patent Application Publication
(10) Pub. No.: US 2025/0275556 A1
(43) Pub. Date: Sep. 4, 2025

(54) NUTRITIONAL SUPPLEMENT AND METHOD FOR PRODUCING THE SAME

(71) Applicant: Kalium Agri, Inc., Greeley, CO (US)

(72) Inventor: Scott Boken, Greeley, CO (US)

(21) Appl. No.: 19/066,654

(22) Filed: Feb. 28, 2025

Related U.S. Application Data
(63) Continuation of application No. 63/559,541, filed on Feb. 29, 2024.

(51) Int. Cl. A23K 20/24; A23K 20/28

(52) U.S. Cl. CPC A23K 20/24; A23K 20/28

(57) ABSTRACT

A nutritional supplement of rumen bypass magnesium and safe and effective potassium and method of making the same. Potassium carbonate and filtered water are reacted in a solution with a ratio of between 40% to 60% potassium carbonate to between 40% to 60% water by weight to obtain potassium carbonate sesquihydrate aqueous solution. The potassium carbonate sesquihydrate aqueous solution is added to anhydrous potassium carbonate. Magnesium chelate is reacted with the anhydrous potassium carbonate to form potassium carbonate sesquihydrate magnesium chelate. The supplement is fed to dairy cows to improve the health, productivity and efficiency of dairy cows.

### CROSS REFERENCE TO RELATED APPLICATION

This application claims priority to provisional application Ser. No. 63/559,541 filed Feb. 29, 2024, and titled “NUTRITIONAL SUPPLEMENT AND METHOD FOR PRODUCING THE SAME” which is hereby incorporated by reference in its entirety.

### FIELD OF THE DISCLOSURE

This disclosure relates generally to a nutritional supplement and method for producing the nutritional supplement. In particular, the disclosure relates to a method for chemically modifying potassium carbonate to potassium carbonate sesquihydrate magnesium chelate in a sequential reaction.

### BACKGROUND OF THE DISCLOSURE

Potassium is an essential nutrient in the diets of dairy cattle, and in the carbonate form has been shown to be a rumen modifier, capable of significantly improving feed digestibility and therefore productivity. Potassium also has several physiological effects, from metabolism to scavenging free radicals as a critical component of antioxidant enzyme complexes. Magnesium is also an essential nutrient in the diets of dairy cattle, having similar physiological features as potassium but is also critical in the protection of the animal's gut. Proper levels of potassium supplementation are difficult to achieve for several reasons. The prevalent and most effective form of Potassium is potassium carbonate, however, the addition of raw potassium carbonate results in extreme heating of the animal's feed, resulting in yeast and mold formation and subsequent poisoning of the feed or feed refusal. Other forms of potassium are unacceptable due to their charge characteristics or inert characteristics. Furthermore, when adequate potassium is fed, magnesium digestion in cattle is significantly depressed as both potassium and magnesium share the same transport site in the rumen (forestomach) of the cow allowing the mineral to cross the blood barrier transported to target tissue. Currently, the most available and preferred form of potassium for nutritional supplementation is potassium carbonate. Potassium carbonate in its raw form is highly reactive to water. When exposed to a small amount of moisture, it undergoes an exothermic reaction causing the temperature of the compound to go to well over 200 degrees Fahrenheit, making it dangerous to handle in feed mills and farms. Such reactions with potassium have resulted in feed mill fires, and “bunk heating” when fed directly in dairy rations. Bunk heating can cause temperatures in the 170 deg F. range and generates molds, yeasts, and decreased intakes as cattle object to the feed. The most common form of magnesium supplemented in cattle is magnesium oxide. However, it is only 19% digestible in optimal situations and, with a potassium challenge, its bioavailability is hindered significantly more resulting in hypo magnesia, down cows and significant deteriorating health conditions of the cow. Dairy cows deficient of adequate levels of potassium and magnesium fail to meet their production potential and optimal health. This makes them less efficient, resulting in a greater carbon footprint than an animal adequately supplemented.

For the reasons stated above, and for other reasons which will become apparent to those skilled in the art upon reading and understanding the specification, there is a need in the art for an improved potassium and magnesium nutritional supplement and production method.

These and other objects, features, or advantages of the present disclosure will become apparent from the specification and claims.

### BRIEF SUMMARY OF THE DISCLOSURE

The disclosure relates to a nutritional supplement and method for its production. The nutritional supplement is produced using a systemic chemical reaction that makes the potassium carbonate non-reactive to water, distributes a highly bioavailable form of magnesium with qualities demonstrated to improve gut wall health, and causes the magnesium to be digested in part of the intestine not common to potassium. This allows for higher supplementation rates of potassium while providing commensurate amounts of magnesium to permit the animal to maximize production, homeostasis, feed efficiency and thus sustainability. In one arrangement, the nutritional supplement is produced in a reaction involving potassium carbonate, liquified magnesium chelate, a solution of hydrated potassium and water. In other embodiments, potassium carbonate and magnesium oxide are chemically modified in their raw forms in a sequential reaction. This sequential reaction results in the formation of resulting in potassium carbonate sesquihydrate magnesium chelate potassium carbonate sesquihydrate magnesium citrate. The resulting supplement, named Balanced K, is a dry, crystalline mineral the consistency of table salt that can be mixed into the rations of dairy cattle on a daily, continuous basis from parturition to the cessation of lactating. There is also application for Balanced K in the feeding of grass-fed organic beef for improved feed conversion.

### BRIEF DESCRIPTION OF THE DRAWINGS

FIG. 1 depicts a systemic reaction for creating Potassium Carbonate Sesquihydrate Magnesium Chelate according to one embodiment.

FIG. 2 depicts another systemic reaction for creating Potassium Carbonate Sesquihydrate Magnesium Chelate according to one embodiment.

FIG. 3 depicts a systemic reaction for creating Potassium Carbonate Sesquihydrate Magnesium Citrate according to one embodiment.

### DETAILED DESCRIPTION

In the following detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosures. The following detailed description is, therefore, not to be taken in a limiting sense, and the scope of the present disclosure is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description and are not intended to be used as limitations. Accordingly, orientation of an object or a combination of objects may change without departing from the scope of the disclosure.

Furthermore, the description herein is made with the understanding that the present disclosure is to be considered as an exemplification of the claimed subject matter, and it is not intended to limit the claims to the specific embodiment as illustrated.

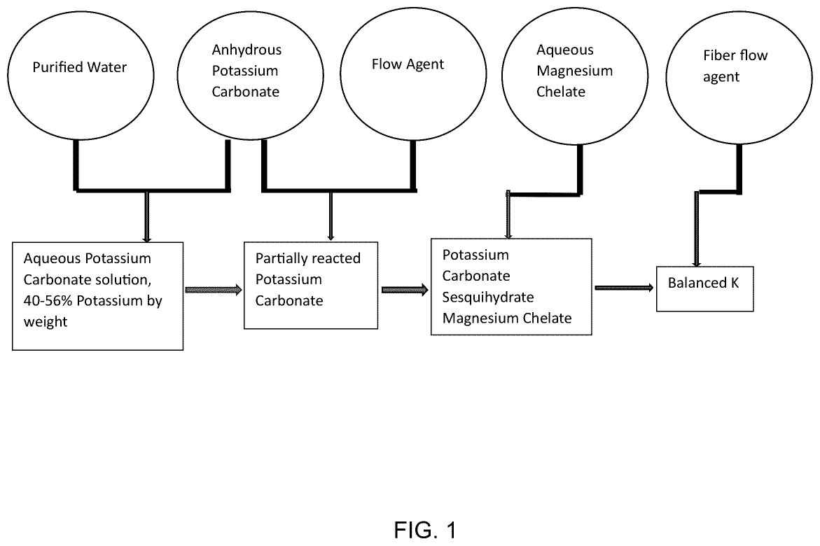

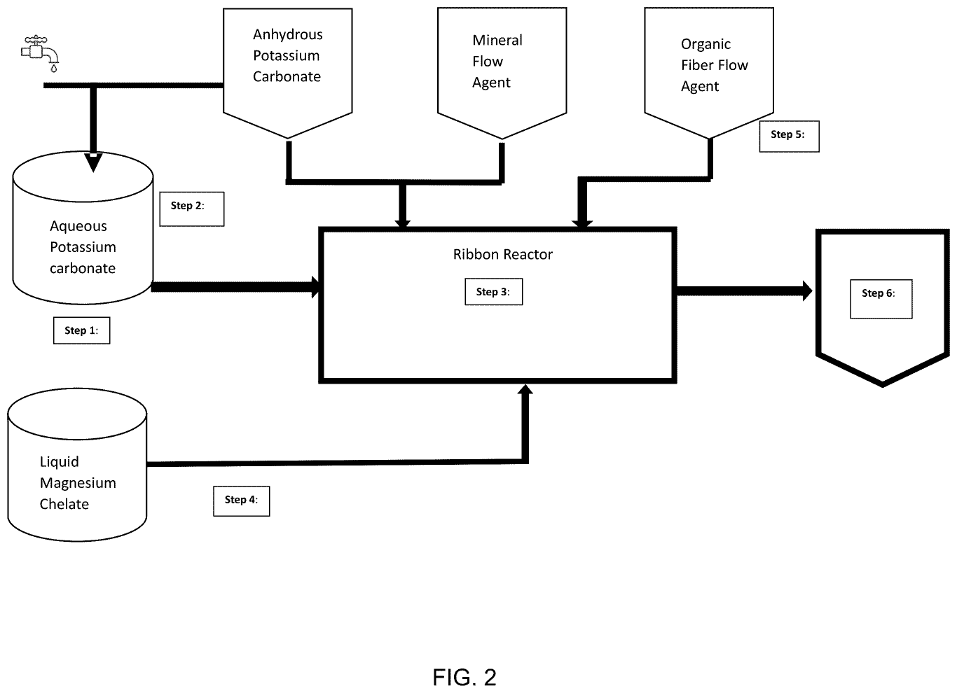

A nutritional supplement, referred to as Balanced K, and method for producing and using the same are disclosed. As shown in FIGS. 1-3, according to exemplary embodiments of the disclosure, potassium carbonate, magnesium chelate, and an aqueous solution of hydrated potassium are reacted in the following manner to produce potassium carbonate sesquihydrate magnesium chelate or potassium carbonate sesquihydrate magnesium citrate. In other embodiments of the disclosure, a reaction involving potassium carbonate, magnesium, magnesium oxide, or liquified magnesium chelate, a solution of hydrated potassium and water. In other embodiments, potassium carbonate and magnesium oxide are chemically modified in their raw forms in a sequential reaction, this sequential reaction results in the formation of resulting in potassium carbonate sesquihydrate magnesium chelate or magnesium citrate.

A series of reactions take place to produce a single batch of Balanced K, each dependent on the other to complete the final reaction. According to one embodiment of the disclosure, in step 1, potassium carbonate is reacted to filtered water in a solution with the following ratio; between 40% and 56% potassium carbonate to between 44% to % 60% water by weight in an upright blending tank that is constantly agitate for a period of up to 1 hour until the specific gravity of the solution has stabilized, indicating a complete reaction. However, any agitation period any percentage of potassium carbonate or water can be utilized without departing from the scope of the disclosure. All of the potassium carbonate in solution is reacted and the precise amount of water needed to react the exact amount of potassium carbonate in the ribbon mixer remains, such that 92-98% of the potassium carbonate becomes hydrated before the liquid magnesium hydrates 2.5% of the anhydrous potassium carbonate. In one embodiment, 40 to 56% by weight potassium carbonate is reacted with 60-44% filtered water. However, any percentage of elements can be utilized without departing from the scope of the disclosure.

An inert organic flow agent is added depending on season and destination to reduce caking and improve product handling before load out. The first reaction results in potassium carbonate sesquihydrate aqueous solution (KCS Aq), and is represented by the following reaction where X represents the mols of water needed to produce between 40 and 60% potassium carbonate hydrate solution:

X(H₂O)+2(K₂CO₃)+3(H₂O)-->C₂H₆K₄O₉+X(H₂O)

In step 2 of the embodiment, potassium carbonate sesquihydrate aqueous solution is precisely added to potassium carbonate (K₂CO₃) in a schedule that allows for between 8 and 10 percent of the final compound to be anhydrous potassium carbonate, 0.016% of final dry weight to be chelated magnesium, between 0 and 1% zeolite flow agent and between 0 and 1% inert fiber byproduct. The latter agents are used to improve product flowability and prevent caking. The KCS Aq is applied to the anhydrous potassium carbonate in a schedule appropriate to the weight of raw material added to the reaction vessel with specifically engineered nozzles appropriate for the viscosity and specific gravity of the KCS Aq being delivered between 150 and 250 psi to complete the entire reaction within 40 minutes. This allows us to achieve significant product uniformity and hydration. In one or more embodiments, a ribbon mixer is filled with anhydrous potassium carbonate to match an amount of aqueous potassium carbonate, filtered water, or KCS Aq and is added 0.05%-1% by final weight flow. However, any percentage of elements can be utilized without departing from the scope of the disclosure.

In step 3 of the embodiment, aqueous magnesium chelate reacts a portion of the anhydrous potassium carbonate with the aqueous magnesium chelate (MgC Aq) completely distributed evenly across the hydrated potassium thus forming potassium carbonate sesquihydrate magnesium chelate. The MgC Aq is applied with specifically engineered spray nozzles appropriate for the viscosity and specific gravity of the MgC Aq in its own spray system with accompanying pumps delivering the MgC Aq within a range of 150 to 250 psi to assure even distribution, potassium hydration and magnesium chelate distribution. In one embodiment, a steady stream of aqueous potassium carbonate is applied to the bed of mineral at a rate of 43.7% and 44.7% of the weight of anhydrous potassium and mineral flow agent and mix between 20 and 40 minutes depending on the amount of anhydrous potassium carbonate added in Step 2. In one embodiment, liquid magnesium chelate is applied at 4% by final weight calculation to complete the hydration reaction and thoroughly distribute the chelated Magnesium, application time is a minimum of 5 minutes. Aqueous magnesium chelate completes the hydration of potassium carbonate within the desired parameters of the mixing schedule seen in FIG. 1 and becomes thoroughly incorporated in the final product. However, any percentage of elements can be utilized without departing from the scope of the disclosure.

The magnesium chelate is a blend of amino acids that have specific activity at the gut wall indicated in improving cellular integrity of the gut. These amino acids also protect the Magnesium from reacting in the rumen and being digested at the rumen level. These amino acids are reacted to Magnesium within the ranges in the table below:

TABLE 1

| Amino Acid | Range of composition |
|---|---|
| Glycine | 25-75% |
| Lysine | 5-20% |
| Threonine | 25-60% |
| Arginine | 1-15% |

The amino acids and magnesium comprise 35% of the compound with water making up the other 65%.

At step 4 an appropriate amount of an inert grain fiber byproduct is blended into the reacted mineral mixture at a rate of 0-1% of final weight to reduce moisture accumulation and prevent caking of the final mix. In one embodiment, 1% of final weight of organic fiber flow agent is added. However, any percentage of elements can be utilized without departing from the scope of the disclosure.

C₆H₆MgO₇+2(H₂O)+2(K₂CO₃)+3(H₂O)-->C₂H₆K₄O₉

At step 5 of the embodiment, the final nutritional supplement product is loaded out. Elements of the resulting supplement are shown in the following table. However, any percentage of elements can be utilized without departing from the scope of the disclosure.

TABLE 2

Percent Anhydrous in Final mix

| Balanced K | 0.08 | 0.09 | 0.1 |
|---|---|---|---|
| Potassium Carbonate (lbs) | 1000 | 1000 | 1000 |
| Liquid Magnesium | 55.27 | 54.67 | 54.07 |
| Chelate | | | |
| Aqueous Potassium | 447.17 | 442.31 | 437.45 |
| Solution (lbs) | | | |
| Flow Agent | 14.47 | 14.42 | 14.37 |
| Mag Chelate | 58.47 | 58.27 | 58.07 |
| Final Yield of Balanced K | 1520.11 | 1515.00 | 1509.89 |
| minutes to react | 40 | 40 | 40 |
| Solution Flow rate (gpm) | 0.90 | 0.89 | 0.88 |

The liquid form of the magnesium chelate completes the reaction of the potassium carbonate hydrate. The resulting compound is potassium carbonate sesquihydrate magnesium chelate, a nutritional supplement named Balanced K. In some embodiments, a release agent, such as a specialized silicone based release agent, that prevents agglomeration of reacting product to metal parts may be used to ensure a thorough reaction and a homogeneous finished particle size.

A mixer, such as coolant jacketed ribbon mixer may be used to hold the chemical compounds and combine the various chemical compounds to initiate or aid in the reactions. In other embodiments, a container with a stirrer may be used to house and mix the chemical compounds. Chemical compounds may be added to the mixer by pouring or spraying or any other method that allows chemical compounds to the mixer. In one embodiment, the sprayer is configured to add one or more chemical compounds to the mixer. The sprayer may have customized liquid solution application manifolds. Variable rate pumps and flow meters may deliver specific weights of liquid solution to the mixer. Spray nozzles may specifically conform to the viscosity and specific gravity of the aqueous solution. The spray nozzles may be designed to only apply solution to the material bed at a specific rate.

A temperature control system, such as a temperature-controlled glycol heat exchange system, to depress heating to maintain the reaction may be used. In one or more embodiments, a temperature <130° F. needs to be maintained in order to improve particle size distribution of final product, Balanced K. In other embodiments, the temperature may be higher or lower or must be kept in a specific range. The range may vary based on the chemical reaction occurring. A reservoir system, such as an agitating liquid reservoir system, may be used with heat exchanger that keeps reacted potassium carbonate in solution and at a desired application temperature.

Balanced K is a dry, crystalline mineral, the consistency of table salt that can be mixed into the rations of dairy cattle on a daily, continuous basis from parturition to the cessation of lactating and beef cattle to harvest. Balanced K has a free-flowing characteristic with consistent particle size. According to one embodiment of the disclosure, Balanced K is a formulated source of no less than 47% potassium on a dry matter basis that will allow nutritionists to feed the optimum levels for production and metabolic reactions without the challenges of heating, dust, hygroscopicity, and clumping.

According to one embodiment of the disclosure, the Balanced K formula is designed to react 95%+−5% of the potassium carbonate while considering the inclusion of flow agent, such as rice hulls, and 4% magnesium chelate, which also is part of the 95%+−5% reaction. The thoroughly distributed 5% anhydrous potassium carbonate, is intended to reduce caking in the packaged product when exposed to humidity. Using a variable rate of the flow agent between 0 and 1% of final product weight to improve particle size distribution depending on ambient conditions of the manufacturing facility. In addition, using a variable rate of an inert mixing ingredient, such as rice hulls, to reduce bulk density of reacting and final product that aids in product handling, product appearance and product usage.

Magnesium chelate is a blend of 4 specific amino acids that has been proven to aid in the gut wall integrity of the animal. The Magnesium chelate is intentionally not digested in the rumen rather is completely digested in the small intestine of the animal. The Magnesium inclusion levels in balanced K are designed to meet the biological weight equivalent of animal test subjects for maximum effectiveness.

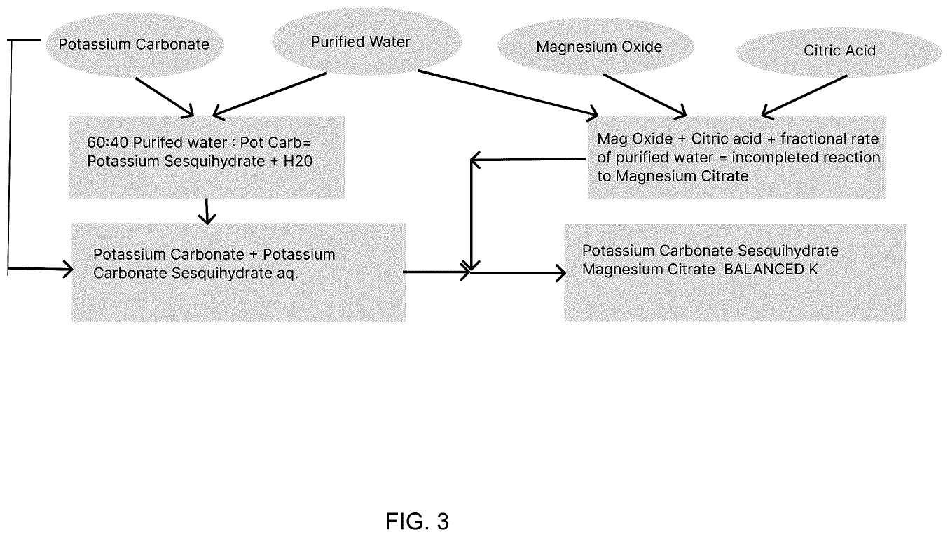

In other exemplary embodiments of the disclosure, as shown in FIG. 3, potassium carbonate, magnesium oxide, citric acid, magnesium glycinate and water may be reacted in the following manner to produce potassium carbonate sesquihydrate magnesium citrate, potassium carbonate sesquihydrate magnesium glycinate, or potassium carbonate sesquihydrate magnesium chelate.

A series of reactions take place to produce a single batch of Balanced K, each dependent on the other to complete the final reaction. According to one embodiment of the disclosure, in step 1, potassium carbonate is reacted to filtered water in a solution with the following ranges: between 40% and 60% potassium carbonate to between 40% to 60% water by weight in an upright blending tank. However, any percentage of potassium carbonate and water can be utilized without departing from the scope of the disclosure. The water in the solution reacts all of the potassium carbonate in solution formula while leaving a calculated amount of water for the subsequent reactions. An agitating liquid reservoir system with heat exchanger may be utilized to keep reacted potassium carbonate in solution and at a desired application temperature. The first reaction results in potassium carbonate sesquihydrate aqueous solution, and is represented by the following reaction where X represents additional purified water to react the desired amount of potassium carbonate in the next step of the process:

X(H₂O)+2(K₂CO₃)+3(H₂O)-->C₂H₆K₄O₉+X(H₂O)

In step 2 of the embodiment, potassium carbonate (K₂CO₃) is added to the potassium carbonate sesquihydrate aqueous solution in the amounts of 33.58% potassium carbonate sesquihydrate aqueous solution and 62.19% potassium carbonate (K₂CO₃) by weight. However, any percentage of potassium carbonate and potassium carbonate sesquihydrate aqueous solution can be utilized without departing from the scope of the disclosure. The potassium carbonate sesquihydrate aqueous solution is added to raw potassium carbonate at a rate necessary to react all of the dry potassium carbonate. In step 3 of the embodiment, the potassium carbonate sesquihydrate aqueous solution and potassium carbonate combined in step 2 are mixed.

In step 4 of the embodiment, magnesium citrate is synthesized. Magnesium oxide (MgO) is partially reacted with citric acid and water, forming a paste of Mg citrate according to the following reaction:

MgO+(C₆+H₈+O₇)+H₂O-->C₆H₆MgO₇+2(H₂O)

Any percentage of citric acid and water can be utilized without departing from the scope of the disclosure. For example, in one embodiment, the concentration of water used in the reaction to form a paste of magnesium citrate chelate is a ratio between 40% and 60%.

At step 5 of the embodiment, the partially reacted magnesium citrate is then added to the reactor vessel to complete the final reaction with the aqueous potassium carbonate solution. The amount of partially reacted magnesium citrate added is 4.30% by weight. However, any amount of partially reacted magnesium citrate can be utilized without departing from the scope of the disclosure. This step is represented by the following reaction:

C₆H₆MgO₇+2(H₂O)+2(K₂CO₃)+3(H₂O)-->C₂H₆K₄O₉

In step 5a, aqueous magnesium chelate instead of magnesium citrate is sprayed onto the potassium carbonate to complete the reaction to potassium carbonate sesquihydrate magnesium chelate or magnesium citrate.

At step 6 of the embodiment, the final nutritional supplement product is loaded out. Elements of the resulting supplement are shown in the following table. However, any percentage of elements can be utilized without departing from the scope of the disclosure.

| | |
|---|---|
| g Magnesium Citrate | 4.23% |
| g Magnesium Chelate | 4.00% |
| g Potassium Carbonate | 62.19% |
| g Potassium Carbonate Aq. | 33.58% |

The resulting compound is potassium carbonate sesquihydrate magnesium chelate or potassium carbonate sesquihydrate magnesium citrate, a nutritional supplement named Balanced K. Balanced K is a dry, crystalline mineral the consistency of table salt that can be mixed into the rations of dairy cattle on a daily, continuous basis from parturition to the cessation of lactating. Balanced K has a free-flowing characteristic with consistent particle size. According to one embodiment of the disclosure, Balanced K is a formulated source of 47% potassium that will allow nutritionists to feed the optimum levels for production and metabolic reactions without the challenges of heating, dust, hygroscopicity, and clumping.

Balanced K prevents competition between potassium and magnesium absorption in the rumen. When appropriate levels of potassium are met using another form of potassium sesquihydrate, magnesium deficiency occurs via out competition at magnesium transfer sites in the forestomach. Adding conventional magnesium oxide is ineffective as it is inert traveling downstream to the small intestine. Balanced K as a molecule changes the site of absorption of magnesium from the rumen wall to the small intestine. Balanced K combines these two antagonistic cations, potassium and magnesium, in the same formula, but eliminates the competition between them, to the benefit of the animal.

Balanced K can be a formulated source of any percentage of potassium that will allow nutritionists to feed the optimum levels for production and metabolic reactions without departing from the scope of the disclosure. Balanced K can be used at the farm level or in the formulation of complete commercial packs, as it is compatible with all ingredients. Balanced K alleviates competition between the absorption of potassium and magnesium by delivering magnesium downstream in the digestive system. This is done during the manufacturing process by creating a protected form of magnesium that is rumen inert, yet highly digestible in the small intestine.

Supplementing adequate amounts of potassium in the form of potassium carbonate sesquihydrate found in Balanced K has been shown in several research studies to organically modify the rumen function of dairy cattle resulting in significant improvements in fiber digestibility, feed efficiency, milk yield, milk fat yield, fatty acid component improvements, and decreased methane production. Furthermore, increased systemic availability of potassium alleviates oxidative stress and improves metabolism as potassium is an essential nutrient for enzyme complexes responsible for these functions. Feeding hydrated potassium carbonate at effective levels does cause a serious depression in the absorption of magnesium which may result in significant health events and depressed immune status of dairy cows. Modern dairy cows are naturally susceptible to hypomagnesia, thus such a challenge may be difficult for many to overcome. This invention alleviates the pressure of a potassium challenge by changing the competitive absorption site for Magnesium from the rumen, where potassium is principally absorbed, and moving it to the small intestine via the technology of amino acid chelation. The chelated magnesium is formulated to resist rumen degradation and be small enough to cross the blood barrier at the intestines resulting in increased blood plasma concentration of magnesium. Such improvements have been shown to: improve conception, reduce oxidative stress, improve innate immunity, improve milk quality (lower somatic cell counts), improve gut wall integrity, and improve overall health of the animal. Furthermore, the amino acid chelates in Balanced K were specifically selected for their proven contribution to gut wall health in multiple species studies. Therefore, adequate supplementation of Balanced K should improve several production parameters, improve reproduction, improve cow health, improve sustainability, decrease carbon footprint, methane emissions and even improve the effluent usability of the manure of supplemented cattle, as potassium is an essential fertilizer component.

While the invention as disclosed uses magnesium citrate or magnesium chelate as the most biologically available form of magnesium synthesized, other forms of magnesium could potentially replace the magnesium citrate without departing from the scope of the disclosure.

The disclosed nutritional supplement and its method of production have many benefits and advantages including, but not limited to, supplementing both potassium and magnesium in potent forms that are safe to handle on farms and at the feed mill. Balanced K is an organic product that has not been bioengineered. Balanced K contributes to international goals of sustainability and reduced carbon footprint of dairy operations. These and other benefits and advantages of the disclosed nutritional supplement and its method of production are apparent from the specification and claims.

What is claimed:

1. A method for producing a nutritional supplement of rumen bypass magnesium and safe and effective potassium comprising:
reacting potassium carbonate and filtered water in a solution to obtain potassium carbonate sesquihydrate in an aqueous solution.

2. The method of claim 1 wherein:
the reacting potassium carbonate and filtered water is in a solution with a ratio of between 40% to 56% potassium carbonate to between 54% to 60% water by weight to obtain potassium carbonate sesquihydrate aqueous solution.

3. The method of claim 1, further comprising:
adding the potassium carbonate sesquihydrate aqueous solution to potassium carbonate; and
adding a flow agent such as zeolite to prevent agglomeration and maintain consistent product particle size.

4. The method of claim 3, further comprising:
adding a release agent to the metal parts of the ribbon mixer to prevent agglomeration of the potassium carbonate sesquihydrate magnesium chelate.

5. The method of claim 1, wherein the mixing of potassium carbonate sesquihydrate aqueous solution and potassium carbonate comprises 33.58% potassium carbonate sesquihydrate aqueous solution and 62.19% potassium carbonate by weight.

6. The method of claim 3, wherein the potassium carbonate sesquihydrate aqueous solution is added to the potassium carbonate using one or more nozzles configured to add the potassium carbonate sesquihydrate aqueous solution at a rate based on the weight of the potassium carbonate sesquihydrate aqueous solution being added to potassium carbonate.

7. The method of claim 1, further comprising:
Agitating the solution of potassium carbonate and filtered water to form potassium carbonate sesquihydrate aqueous solution until a specific gravity of potassium carbonate sesquihydrate aqueous solution is stable.

8. A method for feeding dairy cows a potassium carbonate sesquihydrate magnesium chelate supplement comprising potassium and magnesium as a mechanism for alleviating the competition between the absorption of potassium and magnesium in the dairy cow, the method comprising: administering to a dairy cow, a potassium carbonate sesquihydrate magnesium chelate supplement configured to change the absorption site of magnesium from the rumen wall to the small intestine.

9. The method of claim 8, further comprising:
improving fiber digestibility of the dairy cow with the potassium carbonate sesquihydrate magnesium chelate supplement.

10. The method of claim 8, further comprising:
improving metabolism of the dairy cow with the potassium carbonate sesquihydrate magnesium chelate supplement.

11. The method of claim 8, further comprising:
alleviating oxidative stress of the dairy cow with the potassium carbonate sesquihydrate magnesium chelate supplement.

12. The method of claim 8, further comprising:
improving gut wall integrity of the dairy cow with the potassium carbonate sesquihydrate magnesium chelate supplement.

13. The method of claim 8, further comprising:
decreasing methane emissions of the dairy cow with the potassium carbonate sesquihydrate magnesium chelate supplement.

14. The method of claim 8, further comprising:
improving immunity of the dairy cow with the potassium carbonate sesquihydrate magnesium chelate supplement.

15. An amino acid compound magnesium chelate.

16. The amino acid compound of claim 15, wherein the magnesium chelate comprises at least 3 amino acids.
